(19) United States
(12) Patent Application Publication
(10) Pub. No.: US 2026/0342672 A1
(43) Pub. Date: Oct. 29, 2026

(54) SYSTEM AND METHOD FOR NETWORK INTELLIGENCE OVER STATIC AND DYNAMIC MULTI PATH DELIVERY

(71) Applicant: Adi ROZENBERG, Shoham (IL)

(72) Inventor: Adi ROZENBERG, Shoham (IL)

(73) Assignee: ALVALINKS LTD., Matan, - (IL)

(21) Appl. No.: 19/695,028

(22) Filed: Jun. 17, 2026

Related U.S. Application Data
(63) Continuation of application No. PCT/IL2025/050257, filed on Mar. 19, 2025.

(51) Int. Cl. H04L 41/147; H04L 43/0888

(52) U.S. Cl. CPC H04L 41/147; H04L 43/0888

(57) ABSTRACT

A system for probing and analysis of network impairments in a dynamic network path including a plurality of paths used for high throughput network traffic to predict an impact of network impairments on current and future traffic, the high throughput traffic has packet streams having data stream characteristics including: a relative ordering of packets, a relative ordering of missing packets, packet and network latency, and packet delay variations, the system comprising: at least one sender block having at least one sender network interface and an injector, the sender block configured to send a plurality of sender packet streams into and out of the at least one sender network interface and at least one receiver block having at least one receiver network interface and a collector, the receiver block configured to receive a plurality of receiver packet streams into and out of the at least one receiver network interface.

### FIELD OF INVENTION AND BACKGROUND

Embodiments of the current invention are related to a system and method for probing and analysis of network impairments occurring over a dynamic network path including multipaths used for high throughput network traffic and particularly video traffic, and specifically to predict an impact of such impairments on future traffic.

In the specification and claims which follow, the terms: “statistics”; “metadata”; and “metadata statistics” have equivalent meanings, namely, data stream characteristics including, but not limited to: relative ordering of and/or missing packets, packet and network latency, and packet delay variations, In the specification and claims which follow, the terms: “stamped metadata information” and “metadata information” have equivalent meanings, namely data stream individual packet characteristic information including, but not limited to: arrival timestamp; TTL; UID, sequence number; watermark; and axillary information, all as known in the art.

The terms “network artifact” and “network impairment”, as used in the specification and claims which follow, have equivalent meaning and are intended to mean an issue that impacts IP packets going through a network from a source to a destination, as known in the art. Examples of network artifacts and/or network impairments include, but are not limited to: a path change in a network stream; delay variation, latency changes, packet reorder, packet loss in transmission due to electrical noise; and packet drop by a congested router.

High throughput traffic in a packet switching networks is very demanding on network elements and resources. With advances made in recent years, some applications use multipath streaming to deliver high throughput content to guarantee error free traffic, continuous delivery, and low latency. Using multipath parallel network paths between the sender and the destination is well known in the art for cellular bonding. Cellular bonding uses several mobile service providers to deliver one media content to one destination with the media content been split among several service providers, so that each service provider carries a portion of the content. A receiver at the destination reaggregates the content portions back into one continuous stream.

Another technique, as known in the art, is Mutlipath TCP (MPTCP). Multipath TCP (MPTCP) aims at allowing a Transmission Control Protocol (TCP) connection to use multiple paths to maximize throughput and increase redundancy, for mission critical applications.

Increasingly more streaming standards are directed to multipath parallel network paths to allow use of higher bandwidth streams, provide lower latency, and enhance reliability. Applying multipath streaming is challenging as respective paths have respective network routes, congestion, and latency. Additionally, the multipath technique may lower the bandwidth or not succeed at all. It is imperative to examine each path and to study the relationship between paths to identify key information such as; overall jitter, latency, round trip delay, packet loss, and route changes so that a receiver can tune its buffer to select the best recovery and for the sender to prioritize paths and to change the allocated ratio between the content portion for each path.

Reference is currently made to FIG. 1, which is a block diagram of a prior art system 1 for passively monitoring the health of a network, the system comprising a sender 2 and a plurality of receivers 3a, 3b connected over one or more internet protocol (IP) networks (NETWORKS A, B, C—7a, 7b, and 7c, respectively) and having respective data streams A, B, C—4 (typ) as shown in the figure. A processing block 5 serves to collect traffic reports and statistics 8 from network elements and agents about the traffic through the network elements and agents. In prior art systems, traffic reports and statistics 8 are obtained by the processing block polling respective networks and receivers known in the art as network elements, for example switches or routers. Processing block 5 then forwards respective traffic statistics 8 to a database 6 for storage and further analysis. The processing unit further analyzes ad hoc information and provides current and historical network status information 9 for a user application 10, which may be a user management system.

Today's network monitoring and health solutions employ passive monitoring of the health of network elements as described and shown hereinabove in FIG. 1 in system 1. The solution gathers statistics from each element to a central processing unit. Significant effort and innovation have taken place in the field in network health monitoring to guarantee network availability.

Some solutions include probing the network routes by way of a ‘ICMP/ping’ or a similar test to determine whether packets are being forwarded to their destination or to determine the number of hops in a route and the time to reach each hop. This technique is called “traceroute”, as known in the art. A test is performed in a time interval of every few seconds to a minute, but test results cannot detect events that are transient because of the low sampling time. The main objective of this traceroute technique is to detect various network elements (i.e., hops), their responsiveness, and the time to respond (which is also referred to as “round trip time” in the art). This technique may be able to detect a slow to non-responding network element that is experiencing congestion or packet loss.

There is therefore a need to actively and continuously send a probing reference stream between end points on the internet and to detect network impairments and traffic degradation, which are indicative of poor delivery for each delivery path, and to apply a receiver processing logic to measure overall traffic outcome. A solution is needed to use probing and measurement to provide real time and historical data of network artifacts to a user in real time. Furthermore, a solution is needed to rapidly predict and detect such problems and to allow a sender or network operator to take action to avoid problems and to enable a continuous delivery of high throughput traffic to its destination.

### SUMMARY OF THE INVENTION

According to one aspect of the present invention, there is provided s system for actively monitoring and evaluating network artifacts on high throughput data over IP based networks, the high throughput data having packet streams with metadata, the streams delivered over a plurality of paths, the packet streams having packets, the system comprising: at least one sender block having at least one sender network interface and an injector, the at least one sender block configured to send a plurality of sender packet streams into and out of the at least one sender network interface; at least one receiver block having at least one receiver network interface and a collector, the at least one receiver block configured to receive a plurality of receiver packet streams into and out of the at least one receiver network interface; a database configured to receive metadata from streams exiting the at least one sender block and metadata of streams entering the at least one receiver block; the plurality of sender packet streams includes at least one source stream and at least one injected stream, the injected stream having packets with stamped metadata information, the injected stream additionally having metadata, and metadata of respective streams into and out of the at least one sender network interface being pushed to the database by the injector; the plurality of receiver packet streams includes at least one test stream having packets with stamped metadata information, at least one reference stream, and a network stream, with metadata of respective streams into and out of the at least one receiver network interface, the metadata being pushed to the databases by the collector; a processing block in communication with the database and with a user application; and wherein the processing block is configured to process metadata and stamped of respective packet streams over the plurality of paths and to interact with the user application and management, the system further configured to measure, alert, and to predict an impact of probed and evaluated network artifacts on future packet streams based on metadata, stamped metadata information, and path analysis. Preferably, the injector and the collector are in communication with a time source, the time source configured to provide timestamping for packets of the at least one injected stream and of at least one reference streams. Most preferably, the stamped metadata information includes at least: a creation timestamp; a time-to-live (TTL); a unique identifier (UID); a sequence number; a watermark; and axillary information.

Typically, the at least one injected stream is an at least one test stream and stamped metadata information of packets of the at least test stream is compared with stamped metadata information of packets of the at least one source stream by the processing block. Most typically, the comparison of metadata by the processing unit includes a determination of: a presence of and an ordering of respective packets; and timing differences of respective packets over the plurality of paths to detect ad hoc network artifacts. Preferably, the processing unit is further configured to examine metadata of packets over time to calculate trends. Most preferably, the processing unit is further configured to alert management of network artifacts and of trends.

According to another aspect of the current invention there is provided a method for actively monitoring and evaluating network artifacts on high throughput data over IP based networks, the high throughput data having packet streams with metadata, the streams delivered over a plurality of paths, the packet streams having packets, the method comprising: taking at least one sender block having at least one sender network interface and an injector, the at least one sender block sending a plurality of sender packet streams into and out of at least one sender network interface; taking at least one receiver block having at least one receiver network interface and a collector, the at least one receiver block receiving a plurality of receiver packet streams into and out of the at least one receiver network interface; configuring a database receiving metadata from packets of streams exiting the at least one sender block and metadata from packets of streams entering the at least one receiver block; whereby the plurality of sender packet streams includes at least one source stream and at least one injected stream, the injected stream having packets with stamped metadata information, the injected stream additionally having metadata, and metadata of respective streams into and out of the at least one sender network interface is pushed to the database by the injector; whereby the plurality of receiver packet streams includes at least one test stream having packets with stamped metadata information, at least one reference stream, and a network stream, with metadata of respective streams into and out of the at least one receiver network interface, the metadata is pushed to the databases by the collector; having a processing block in communication with the database and with a user application; and whereby the processing block processes metadata and stamped metadata information of respective packet streams over the plurality of paths and interacts with the user application and management, the system further configured to measure, alert, and predict an impact of probed and evaluated network artifacts on future packet streams based on metadata, stamped metadata information, and path analysis. Preferably, the injector and the collector communicate with a time source, the time source providing timestamping for packets of the at least one injected stream and of at least one reference streams. Most preferably, whereby metadata includes at least: at least: a creation timestamp; a time-to-live (TTL); a unique identifier (UID); a sequence number; a watermark; and axillary information. Typically, the at least one injected stream is at least one test stream, and the processing block compares stamped metadata information of packets of the at least test stream with stamped metadata information of packets of the at least one source stream.

Most typically, comparing metadata by the processing unit includes determining: a presence of and an ordering of respective packets; and timing differences of respective packets over the plurality of paths to detect ad hoc network artifacts. Preferably, the processing unit further examines metadata of packets over time to calculate trends. Most preferably, the processing unit further alerts management of network artifacts and of trends.

### LIST OF DRAWINGS

The invention is described herein, by way of example only, with reference to the accompanying drawings, wherein:

FIG. 1 is a block diagram of a prior art system for passively monitoring the health of a network, the system comprising a sender and a plurality of receivers connected over one or more IP networks;

FIGS. 2A and 2B are block diagrams of a first system (FIG. 2A) and a second system (FIG. 2B) to actively monitor the health of one or more IP networks, respectively, the systems having data streams A, B, C, in accordance with embodiments of the current invention:

FIGS. 3A, 3B, and 3C are respective block diagrams of sender blocks, including an injector, a source stream, and respective network interfaces in accordance with embodiments of the current invention;

FIGS. 4A, 4B, and 4C are respective block diagrams of receiver blocks, including a collector and respective network interfaces in accordance with embodiments of the current invention;

FIG. 5 is a flowchart showing steps performed by the processing block of FIGS. 2A and 2B to extract information from the metadata of streams between respective senders and receivers, in accordance with embodiments of the current invention;

FIG. 6A is a first timeline versus packet diagram illustrating a test packet stream evaluation between source stream packets and received packets in path 1 stream and in path 2 stream, in accordance with embodiments of the current invention;

FIG. 6B is a second timeline versus packet diagram illustrating a test packet stream evaluation between source stream packets and received packets in path 1 stream and path 2 stream, in accordance with embodiments of the current invention;

FIG. 6C is a third timeline versus packet diagram illustrating a test packet stream evaluation between source stream packets and received packets, in accordance with embodiments of the current invention; and

FIG. 7 is a block diagram 950 illustrating exemplary messages and calculated trend information sent from the processing block to the user application (user management and orchestration) of FIGS. 2A and 2B, in accordance with embodiments of the current invention.

### DETAILED DESCRIPTION

Embodiments of the current invention are related to a system and method for probing and analysis of network impairments occurring over a dynamic network path including multipaths used for high throughput network traffic and particularly video traffic, and specifically to predict an impact of such impairments on future traffic.

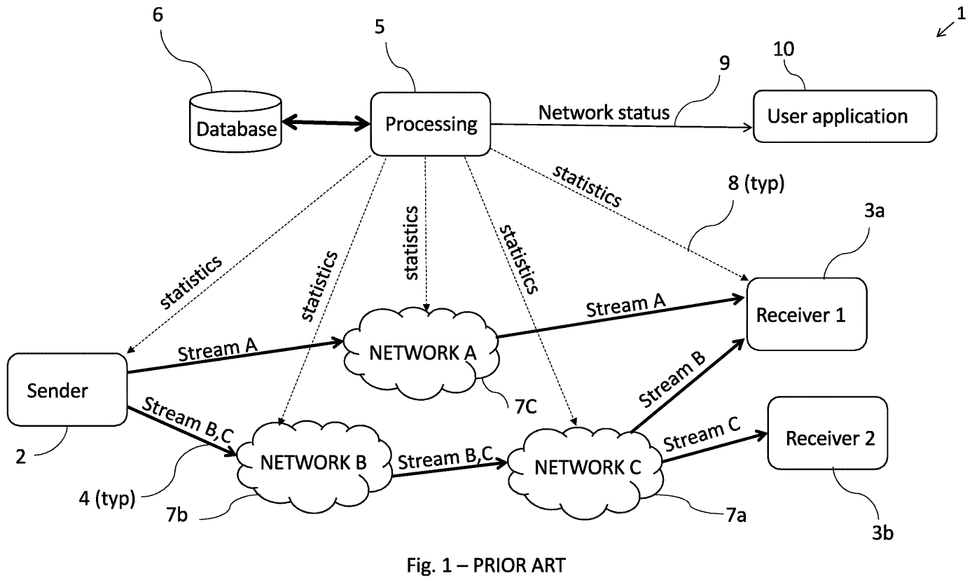

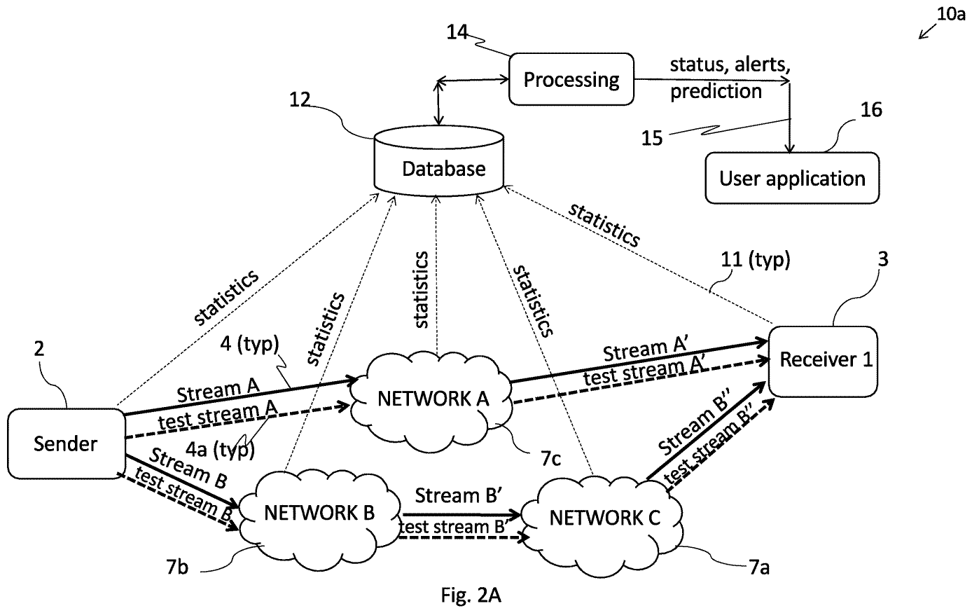

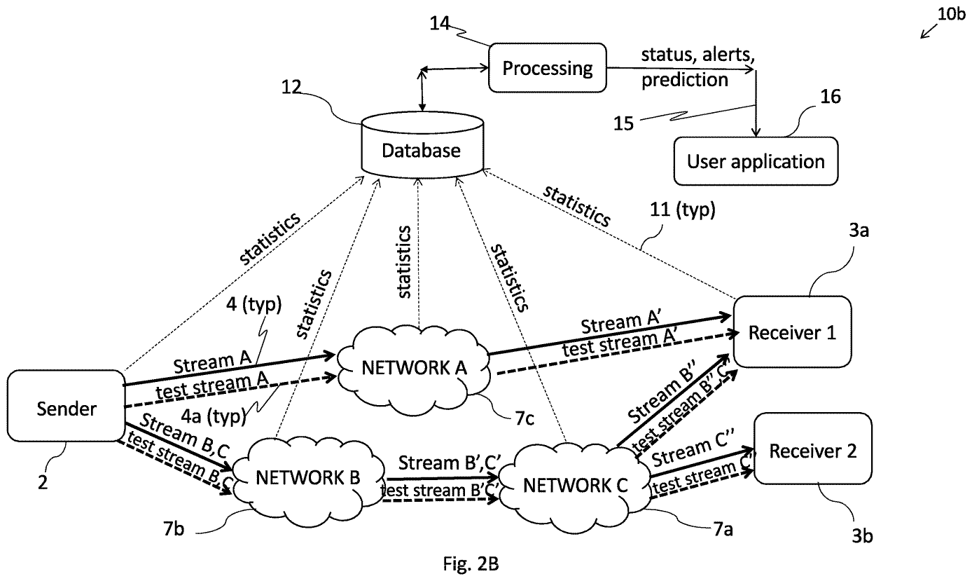

Reference is currently made to FIGS. 2A and 2B, which are block diagrams of a first system 10a (FIG. 2A) and a second system 10b (FIG. 2B) to actively monitor the health of one or more IP networks 7a, 7b, and 7c, respectively, the systems having data streams A, B, C 4 (typ), in accordance with embodiments of the current invention. Similar to that shown in FIG. 1, first system 10a (FIG. 2A) and second system 10b (FIG. 2B) comprise a sender 2 and a receiver 3 (FIG. 2A, first system 10a) or a plurality of receivers 3a and 3b (FIG. 2B, second system 10b) connected over the one or more IP networks (indicated in respective figures as NETWORKS A, B, C). The senders and receivers work together, with the senders sending predefined respective test streams 4a (typ) using the respective networks—the respective test streams having packets, as known in the art.

Metadata statistics 11 from respective sent and received streams and test streams are sent to a database 12 and for processing by a processing block 14. As described and shown further hereinbelow, metadata statistics are in fact preprocessed prior to being stored in the database.

Embodiments of the current invention include statistics “pushing” to the database—as opposed to statistics polling, as known in the art (ref FIG. 1). The processing block examines metadata statistics 11 and other data (as described further hereinbelow), comparing metadata from sent versus received streams for ad hoc network artifacts, and the processing block further serves to examine metadata statistics 11 against historical metadata statistics (stored in the database) to detect/determine trends. Trend information 15, including: status; alerts; and prediction information is made available to user management and orchestration systems, identified in the figures as a user application 16. As indicated in the figures, trend information 15 is also stored in database 12 for further historical analysis and trend predictions.

In both FIGS. 2A and 2B, the sender sends test streams 4a through NETWORKS A, B, and C. Both test streams A and B are generated from a same original test stream (not indicated in the figures), and both test streams A and B share a same UID, a water marker, a sequential sequence number and a creation timestamp. Test stream 4a may represent a portion of the original data stream, stream 4, or a complete copy of stream 4. Respective receivers 3a, 3b collect respective streams 4 and respective test streams 4a and the receivers identify the respective test streams as belonging to the same stream by comparing respective UID, water mark, and the sequential enumeration of numbering and timestamp, as described further below.

Respective streams exiting NETWORKS A, B, and C in FIGS. 2A and 2B bear a notation of ‘(i.e. Stream A’) or of ‘ ’ (i.e. Stream B′) but have not been identified separately with separate indicia solely for purposes of simplification in the current figures. Similarly, such streams are indicated separately with an “a” identification in subsequent figures hereinbelow, because in both the current figure and in subsequent figures, respective network interfaces can introduce different encapsulation.

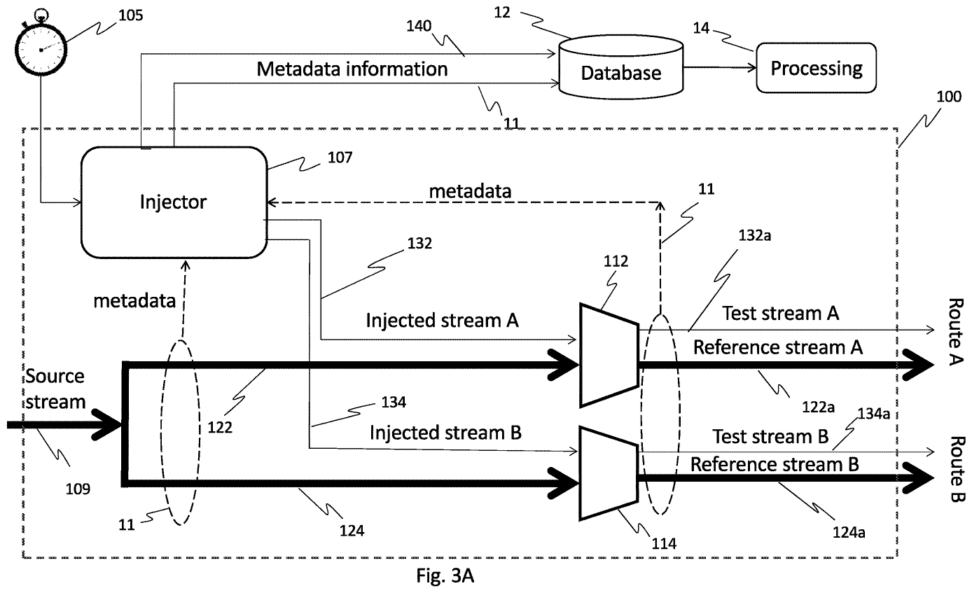

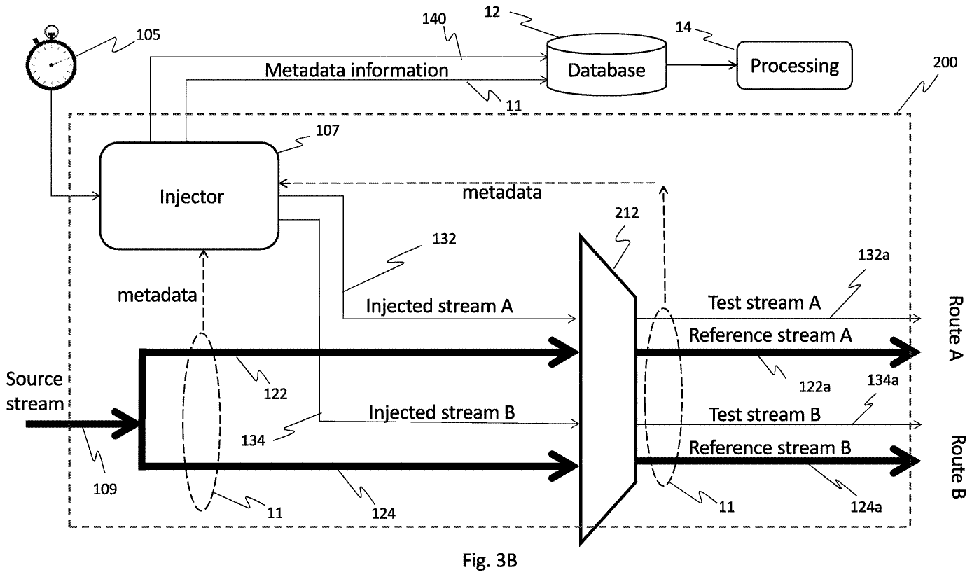

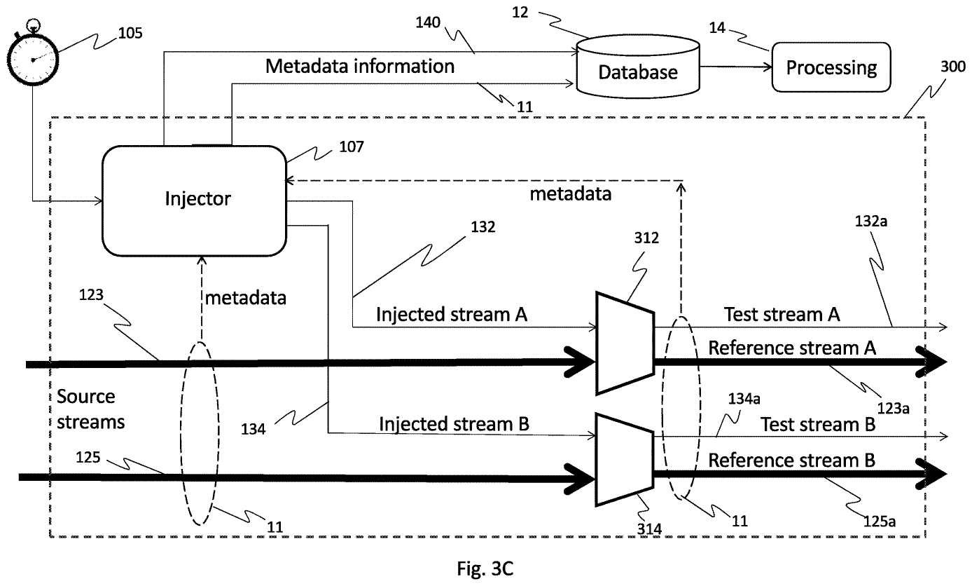

Reference is currently made to FIGS. 3A, 3B, and 3C which are respective block diagrams of sender blocks 100, 200, 300, including an injector 107, a source stream 109, and respective network interfaces 112, 114 (FIGS. 3A), 212 (FIG. 3B), and 312, 314 (FIG. 3C), in accordance with embodiments of the current invention. Elements indicated by the same indicia in FIGS. 3A, 3B, and 3C are generally identical in configuration, operation, and functionality as described hereinabove in FIGS. 2A and 2B. A time source 105, such as a network time protocol (NTP) or a precision time protocol PTP, as known in the art, and database 12 and processing block 14 of FIGS. 2A and 2B, are included in the figures for completeness.

In FIGS. 3A and 3B, source stream 109 is divided into two streams 122 and 124, respectively, representing a plurality of streams. Injector 107 collects metadata statistics 11 from respective streams 122 and 124 going into the respective network interfaces respective streams, and from reference streams A and B, 122a and 124a emerging from the respective network interfaces, and metadata statistics 11 are forwarded to database 12.

The injector receives time information from time source 105 to create respective injected streams (injected stream A, injected stream B) 132, 134 which include respective test packets, each having respective packet stamped metadata information including: a unique identifier (UID); a creation timestamp; a sequence number; a TTL; a varying MTU payload; a packet watermark; and an auxiliary information. Respective injected streams 132 and 134 are forwarded to one or more network interfaces. Test streams A and B, 132a and 134a emerge from the respective network interfaces. Test streams A and B, 132a and 124a are essentially the same as injected streams A and B 132 and 124 and their respective timestamp metadata is the same. Similarly, reference streams A and B, 122a and 124a are essentially the same as two streams 122 and 124 and their respective metadata is the same.

However, because the respective network interfaces can introduce different encapsulation, the respective test and referenced streams have a separate “a” identification. Each network interface connects to a different network path as shown in the figures. The injector sends respective test packet stamped metadata information 140 (belonging to respective injected streams) to database 12.

Except for the different encapsulation noted hereinabove, in the current figures, including FIG. 3C, and in the claims which follow the terms “injected stream” and “test stream” are used/may be used interchangeably. Similarly, the terms “source stream” (when referring to a stream derived from the source stream and which enters the network interface) and “reference stream”, in the current figures, including FIG. 3C, and in the claims which follow are used/may be used interchangeably.

FIG. 3C is essentially similar to FIG. 3A, however source stream 109 is not identified in FIG. 3C (as is in FIGS. 3A and 3B)—rather source streams 123 and 125 in FIG. 3C respectively represent a plurality of independent sources streams. Similarly, reference streams A and B, 123a and 125a, emerging from the respective network interfaces are essentially the same as source streams 123 and 125 and their respective timestamp metadata is the same. However, because the respective network interfaces may encapsulate the respective source streams into respective VPN/VLAN/tunnels respective test and referenced streams have a separate “a” identification, as in FIG. 3A and B.

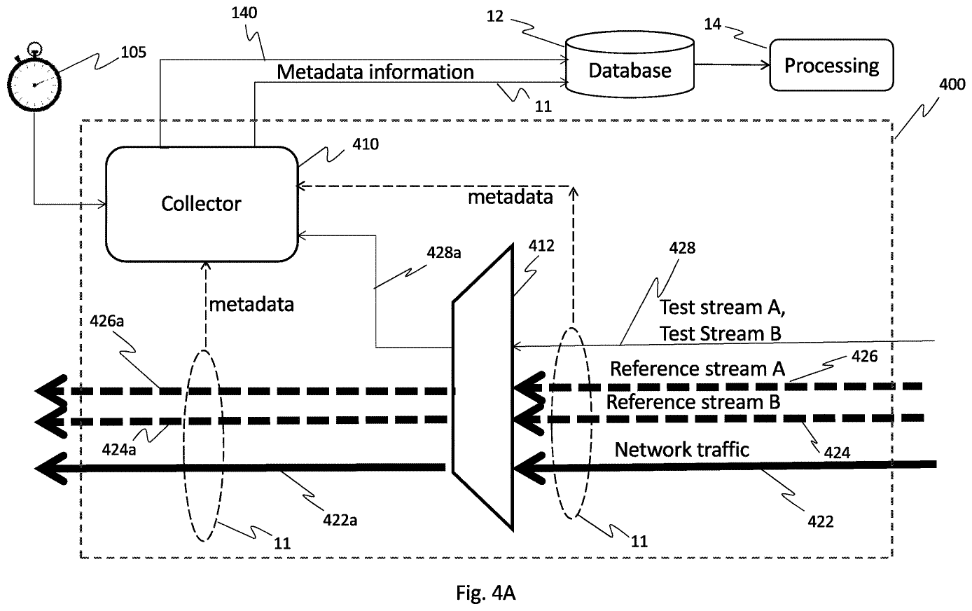

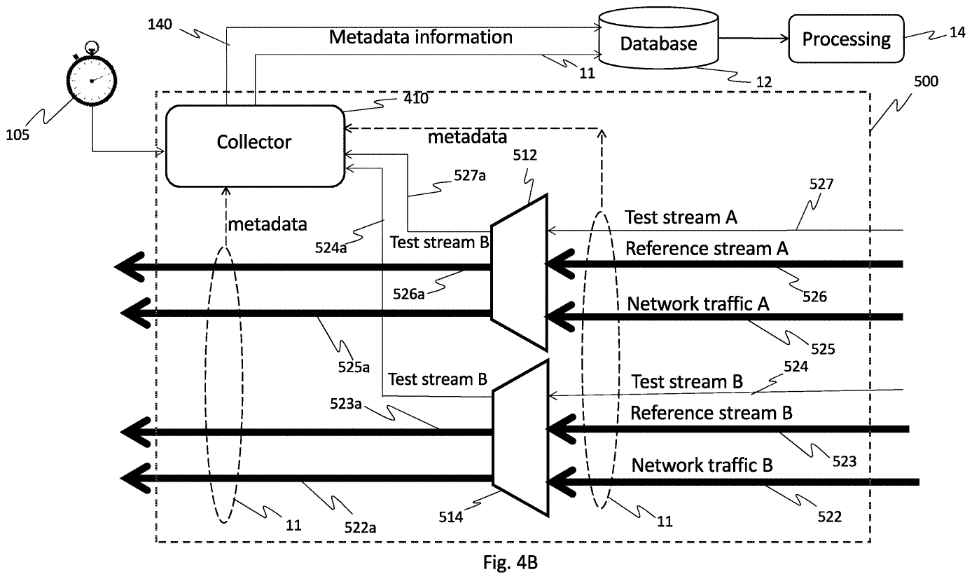

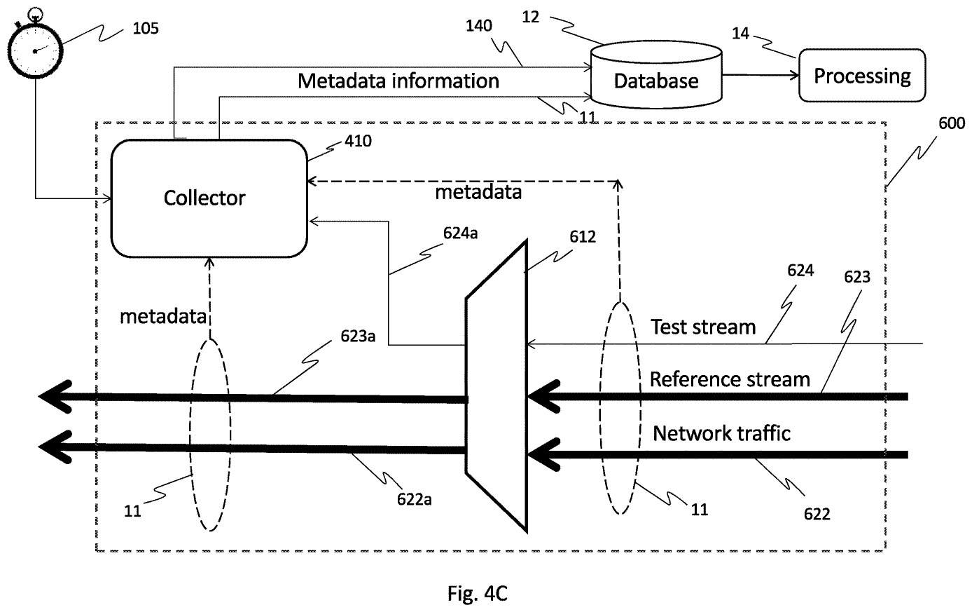

Reference is currently made to FIGS. 4A, 4B, and 4C, which are respective block diagrams of receiver blocks 400, 500, 600, including a collector 410 and respective network interfaces 412 (FIGS. 4A), 512, 514 (FIG. 4B), and 612 (FIG. 4C), in accordance with embodiments of the current invention. Elements indicated by the same indicia in FIGS. 4A, 4B, and 4C are generally identical in configuration, operation, and functionality as described hereinabove in FIGS. 3A and 3B and 3C. Time source 105, database 12, and processing block 14 of FIGS. 3A, 3B, and 3C are included in the figures for completeness.

As shown in FIGS. 4A and 4C, collector 410 serves to collect and preprocess metadata statistics 11 of the streams going in and going out of single local network interfaces 412 and 612 and respective one or more test streams 428 and 624, and reference streams 424, 426, and 623. Metadata statistics are forwarded to database 12 by way of the collector. The collector detects respective test stream UID's and collects respective time information of each received test packet stream including a timestamp (from time source 105), sequence number, TTL, varying MTU payload, packet watermark, and auxiliary information attached to the packet payload.

The collector further sends respective test packet metadata information 140, including arrival timestamp (based on time source 105), TTL, sequence number, watermark, and axillary information to the database. Similar to the stream configuration described hereinabove in FIGS. 3A, 3B, and 3C, the “a” notation is appended to indicate a relationship between respective streams entering and emerging from respective network interphases.

In FIG. 4B, the collector similarly serves to collect and preprocess metadata statistics 11 of the streams going in and out of a plurality of local network interfaces 512 and 514 and a plurality of reference streams 523, and 536 and test streams 524 and 527 that user management is interested in inspecting. (Network traffic A and B 522 and 525 represent other network traffic going in and out of the local network interfaces.) Statistics 11 are forwarded to the database. The collector detects respective test stream UID's and collects respective time information of each received test packet stream including a timestamp, sequence number, TTL, varying MTU payload, packet watermark, and auxiliary information attached to the packet payload—all of which is sent to the database.

As indicated in FIGS. 3A, 3B, and 3C, one or more source streams are part of respective sender block configurations 100, 200, and 300; whereas in FIGS. 4A, 4B, and 4C one or more test, reference, and network streams are part of respective receiver block configurations 400, 500, and 600. Both sending and receiving blocks described hereinabove include embodiments of the current invention adapted to data streams having a single route, a multipath virtual route, and a multi path with dynamic packet spread (or load-balanced) selective mode of operation.

Except for the different encapsulation as noted hereinabove, in FIGS. 3A, 3B, and 3C, the terms “test stream” and “reference stream” used in FIGS. 4A, 4B, and 4C are respectively the “injected stream” and “source stream” of respective block diagrams of sender blocks 100, 200, 300, in FIGS. 3A, 3B, and 3C.

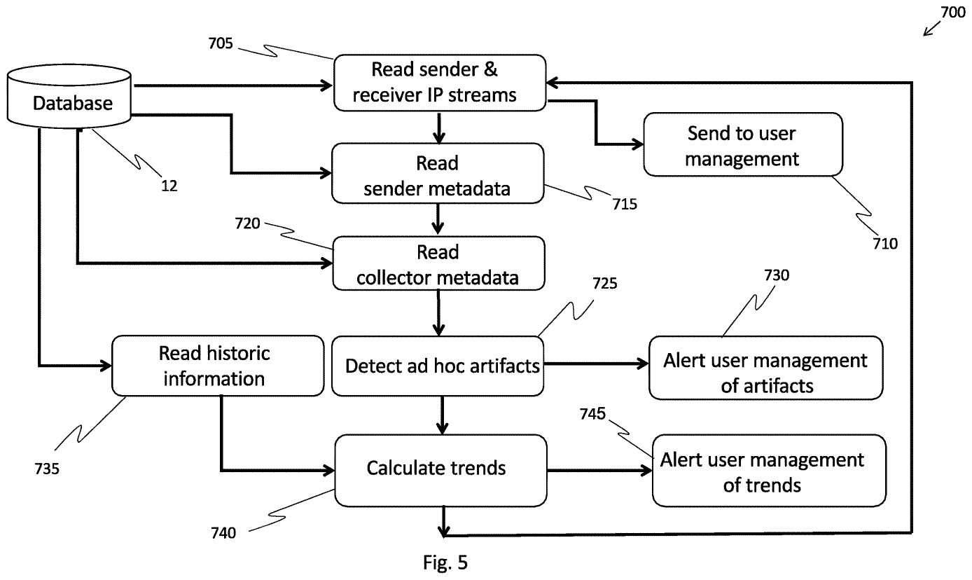

Reference is currently made to FIG. 5, which is a flowchart 700 showing steps performed by processing block 14 of FIGS. 2A and 2B to extract information from the metadata of streams between respective senders and receivers, in accordance with embodiments of the current invention. As described hereinabove, metadata is stored in database 12, and information from the database is available to processing block 14 for the steps in flowchart 700.

In step 705, Read sender & receiver IP streams, the processing block reads respective sender and receiver IP packets and in step 710, Send to user management, packet information related to respective streams, such as, but not limited to the metadata/source/timing characteristics of a respective stream is sent to user management. Following step 705, in step 715 Read sender metadata, and in step 720 Read collector metadata, the metadata of respective streams are read. As noted hereinabove, metadata includes—but is not limited to—flow identification parameters; source IP; source port; destination IP; destination port; IP protocol; packet rate; MTU size variation; and jitter variation. The processed information is sent to user management.

In step 725, Detect ad hoc artifacts, because the read sender metadata and collector metadata correspond to a single test packet stream, a number of calculations/detections are performed, as described hereinbelow. Processing metadata is performed in step 725 to: detect packets present in the sender metadata but which are missing from the collector; calculate a delay variation of the received test packet stream by the collector; calculate a variation for each test packet between the sender and the collector; detect a network variation created by the network; calculate a histogram of the results; detect burst loss length on the collector stream; detect a reordered packet window; calculate TTL changes between sender and collector; alert of changes in TTL, and calculate RTT changes between sender and collector. In step 730, Alert user management of artifacts, artifacts obtained in step 725 are sent to user management.

In step 735, Read historic information, historic information available from database 110 is read and in step 740, Calculate trends, the historic information is compared to the new calculated artifact information from step 725 to detect/determine trends that may only be visible over time. Such trends include but are not limited to: a latency increase indicating a network element starting to be congested; TTL changes indicating a new route on the network; and a packet loss repetition signaling repetitive network over usage by other flows. In step 745 Alert user management of trends, the trend information gathered in step 740 is sent to user management. Following step 740, control reverts back to step 705.

Some of the terminology and concepts noted hereinabove in FIG. 5 are further elucidated hereinbelow.

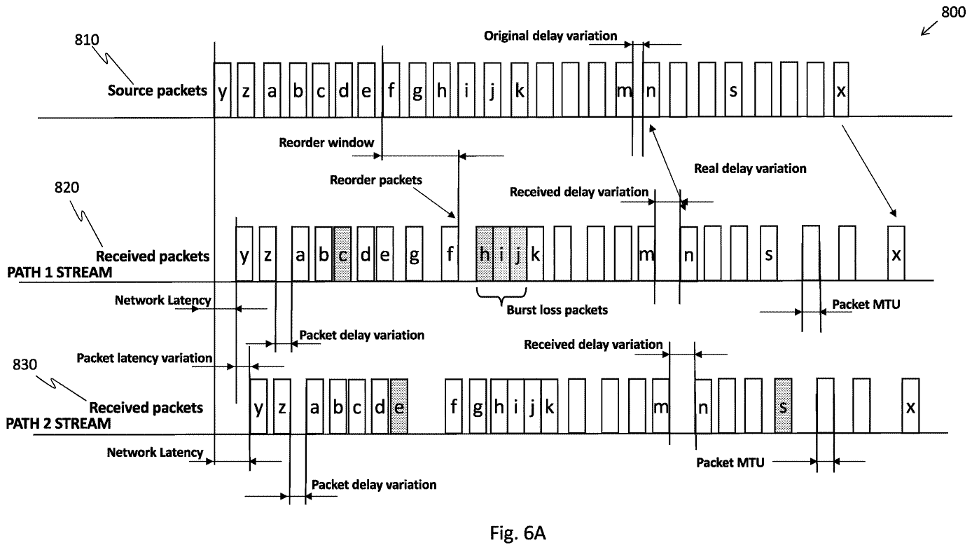

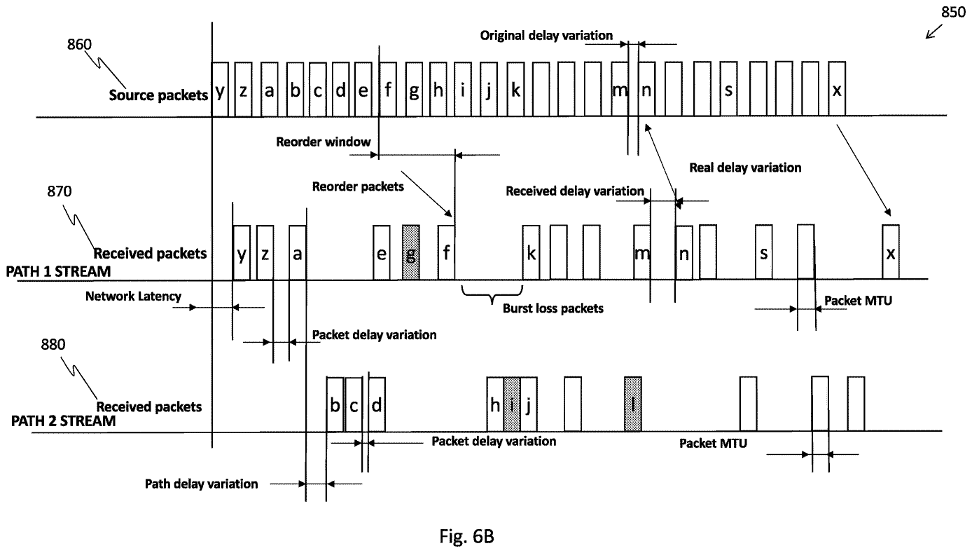

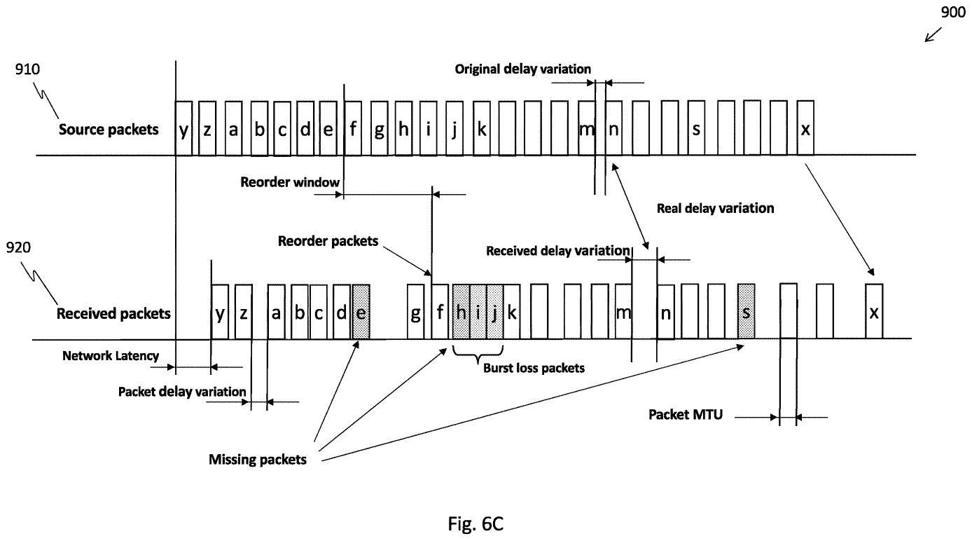

Reference is currently made to FIG. 6A, which is a first timeline versus packet diagram 800 illustrating a test packet stream evaluation between source stream packets 810 and received stream packets in path 1 stream 820 and in path 2 stream 830, in accordance with embodiments of the current invention. Packet diagram 800 serves as a packet-level description of FIGS. 3C, 4A, and 4B, specifically where source and test streams are either split or duplicated and when two or more streams are used.

In FIG. 6A, respective received packets 820 and 830 (of path 1 and 2 streams, respectively) carry a portion of source packets 810 (of the source stream) and the respective received packets may experience different network impairments—such as but not limited to: delay variation; packet loss; burst; and reordering. Received packets 820 and 830 (corresponding to path 1 and 2 streams, respectively) are individually evaluated against respective source stream packets 810. Individual packets are identified in the figure with an alphabetic notation (a, b, c, d . . . ) for the sake of clarity.

FIG. 6A illustrates how metadata gathered from two or more paths is used to evaluate a multipath scenario. As noted hereinabove in FIGS. 2A and 2B, processing block 14 (which receives data from database 12) serves to collect the various statistics and artifacts to create trend information 15 which is sent to user application 16, namely user management. Trend information is also sent to the database for further historical analysis and trend predictions.

For example, for path 1 stream (received packets 820) compared to source packets 810 an arrival time difference between y shows a network latency (as indicated in path 1) for packet y. Collecting network latency information over time yields a histogram of network-introduced delay variations. Measuring a time difference between packets z and a yields a packet delay variation (also known in the art as “jitter”), which is introduced in the route from the sender to the receiver. A comparison of source packets 810 and packets of path 1 stream 820 (with packet shading indicating a missing packet) indicates missing packets c, h, i, j, which signals a packet drop (also indicated as “Burst loss packets” in the figure). The processing block gathers the loss length (in the example a length of 1 for packet c and a length of 3 for packets h, i, j) and respective timing to report and to perform follow-up trend predictions.

Also, on path 1 stream 820 it is seen that packet g is reordered, with packet g appearing before packet f, in contrast to the order of source packets 810. Viewing source packets 810 and comparing an original time difference between m and n (indicated in the figure as “Original delay variation”) versus respective timing variations in received packets 820 and 830 (indicated in the figure as “Received delay variation”) allows determination of network-introduced variations versus the original variation of a data stream over the network.

Comparing path 1 stream received packets 820 and path 2 stream received packets 830 with source packets 810 also shows a network latency for packet y for both path 1 and 2 streams.

In the example of the current figure, injected streams 132,134 of FIG. 3A and collected test streams 524a and 527a of FIGS. 4A and 4B are “reaggregated”. Collector 410 serves to use path 1 stream 820 and path 2 stream 830 packets of FIG. 6A to aggregate the streams into one stream, and to determine latencies between the two streams. A reaggregated stream (not shown in the figures) serves to produce additional information such as; a packet delay variation between source packets 810 and received packets 820 due to a latency of the different paths and recovering a lost packet that may have dropped on path 1 stream 820 but exists on path 2 stream 830 (for example source packet c, which was dropped in path 1 stream 820, can be recovered as packet c in path 2 stream 830 or vice versa, so that the packet is in fact not considered “lost”. The metadata information is collected as an aggregate stream and sent to the database as metadata information 140 (ref FIGS. 2A and 2B) for further analysis.

Reference is currently made to FIG. 6B, which is second timeline versus packet diagram 850 illustrating a test packet stream evaluation between source stream packets 860 and received stream packets in path 1 stream 870 and path 2 stream 880, in accordance with embodiments of the current invention. Packet diagram 850 serves as a packet-level description of FIGS. 3A, 3B, 4A, and 4B, specifically where a source stream is intentionally or unintentionally split into a plurality of streams (i.e. two or more streams)—meaning the source stream was not duplicated in its entirety. Such a configuration is typical when the user elects to use a dynamic load share (i.e. splitting the source stream across multiple paths).

In FIG. 6B, similar to the configuration of 6A hereinabove, respective received packets 870 and 880 (of paths 1 and 2, respectively) carry a portion of source packets 860 (of the source stream) and the respective received packets may experience different network impairments—such as but not limited to: delay variation; packet loss; burst; and reordering. Received packets 870 and 880 (corresponding to path 1 and 2 streams, respectively) are individually evaluated against respective source stream packets 860. Individual packets are identified using an alphabetic notation (a, b, c, d . . . ) for the sake of clarity.

Similar to the examples described in FIG. 6A, hereinabove, in FIG. 6B for path 1 (received packets 870) compared to source packets 860: an arrival time difference between y shows a network latency for packet y. Collecting network latency information over time yields a histogram of network-introduced delay variations. Measuring a time difference between packets z and a yields a packet delay variation (also known in the art as “jitter”), which has been introduced in the route from the sender to the receiver. Similar packet analysis regarding different network impairments are shown in FIG. 6B.

Reference is currently made to FIG. 6C, which is third timeline versus packet diagram 900 illustrating a test packet stream evaluation between source stream packets 910 and received packets 920, in accordance with embodiments of the current invention.

In the current figure, similar to receiver block 600 of FIG. 4C, two copies of test packet streams are sent over two different paths. While respective paths carry the initially same packet stream copy, packet streams may experience different network impairments (delay variation, packet loss, burst, reordering etc.). Each incoming packet over a given path from the sender is evaluated against the same packet information in the collector. For example, viewing received packets 920 in FIG. 6C: an arrival time difference between y shows a network latency for packet y and collection of this information serves to build a histogram of network introduced delay variations. Measuring the time difference between packets z and a (in 920 received packets) serves to show a packet delay variation (also known as “jitter” in the art) introduced into the route from the sender to the collector. A comparison of packet e, h, i, j, and s in received packets 920 with the source packets reveals the absence of the missing packet (otherwise known as “packet drop”). Processing block 12 of FIGS. 2A and 2B serves to gather metadata re packet loss and timing for reporting and follow-up trend prediction.

Packets g, f of received packets 920 are reordered. Additionally, comparing the original time difference between m and n in source packets 910 versus the timing in the collector (received packets 920)—which shows an Original delay variation versus a Received delay variation, as indicated in the figure) enables determination of network-introduced variations versus an original variation of any data stream going over the network.

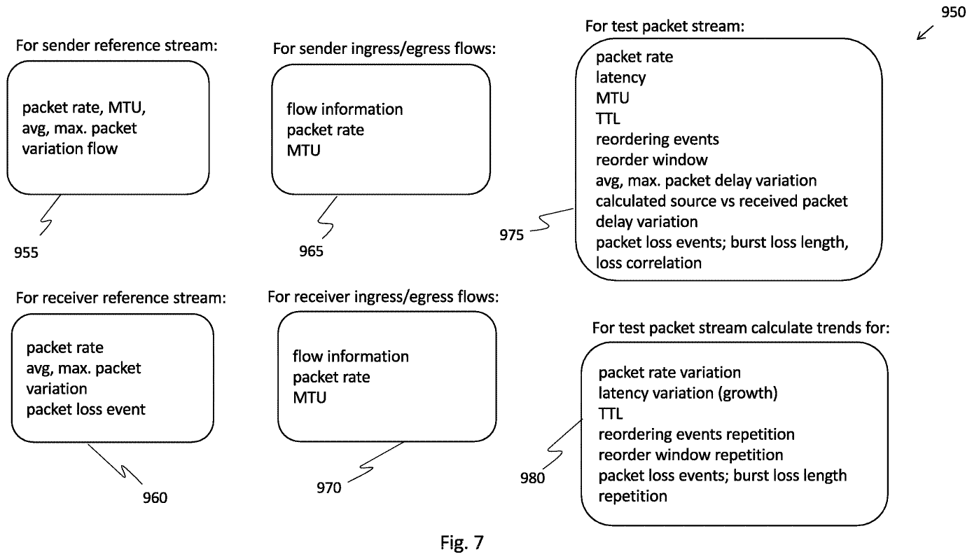

Reference is currently made to FIG. 7, which is a block diagram 950 illustrating exemplary messages and calculated trend information sent from processing block 14 to user application 16 (user management and orchestration) of FIGS. 2A and 2B, in accordance with embodiments of the current invention. Messages and calculated trend information presented in diagram 950 include statistics about the sender reference streams, receiver reference stream, sender ingress/egress IP flows, and receiver ingress/egress IP flows—all of which are standard industry network statistics used by network health systems. Messages and calculated trend information include:
sender reference stream 955, including: packet rate, MTU, average and maximum packet variation flow;
receiver reference stream 960, including: packet rate, MTU, average and maximum packet variation, and packet loss event flow;
sender ingress/egress flows 965, including: flow information, packet rate, and MTU;
receiver ingress/egress flows 970, including: flow information, packet rate, and MTU;
test packet stream 975, including: key rate, latency, MTU, TTL, reordering events, reorder window, average and maximum packet delay variations, calculated source versus received packet delay variation, packet loss events, burst loss length, and loss correlation; and
test packet stream calculated trends for 980, including: packet rate variation, latency variation (growth), TTL, reordering events repetition, reorder window repetition, packet loss events, and burst loss length repetition.

As noted hereinabove, embodiments of the current invention serve to apply new information such as the measurements gathered about test packet streams which are reflected by network artifacts occurring on all the streams and IP flows between respective senders and respective receivers. The processing unit serves to update current ad hoc states of the network, jitter, packet loss, reordering, MTU, TTL changes, among other information. The processing unit further calculates and serves to predict trends by comparing multiple historical reports to identify trends of events that serve to indicate an event repetition in time, and network congestion built up, inter alia. The prediction may be then used to choose different network routes, create a new routing location to divert some of the traffic between multiple routes, or recondition the source IP flow to change its pace, and extend buffer time, inter alia.

The following discussion summarizes benefits of embodiments of the current invention.

Embodiments of the current invention relate to probing and analysis of network impairment on any network traffic and especially for high throughput network traffic and particularly for video traffic carried over one, two, or more different network paths (also known in the art as “routes”). Embodiments of the current invention include a method to detect and predict network impairments on respective network paths and combined network impairments on current traffic and future traffic through a network.

Embodiments of the current invention employ a system to actively send/inject a probing reference stream between end points on the internet to detect network impairments and delivery degradation resulting in poor delivery for each path, and a receiver processing logic to measure an overall outcome and report to a user/sender/network operator. The system rapidly predicts and detects such problems, thereby allowing the sender or network operator to take action to avoid the problem to enable continuous delivery of high throughput traffic to a destination.

For example, an uncompressed SDI video stream also known in the art as SMPTE2110, must be delivered as two identical copies over two paths at a very low delay. As each path uses different equipment and a different network, packet loss and jitter may occur for each path. It is desirable to monitor each path for such events and to additionally identify other possible combined outcomes and report the math to path jitter, latency, and packet loss. Any deviation from a fixed latency, packet loss, or excessive jitter results in poor video for a plurality of viewers.

Embodiments of the current invention include a system that injects information into the network with selective and pre-defined packets that are detected by a plurality of receivers. A sender of the system prepares the packets, each having a Unique Identifier (UID), sequential enumeration, timestamp, watermark, and additional information in the packet payload. The packets are then injected into the network and the packets arrive at a receiver using the same routes as a reference network streams between an origin and a destination site. The receiver inspects incoming traffic and detects the injected packet stream by inspecting the packet UID, watermark and embedded payload information. Because the network may include many such streams, the ability to differentiate between different streams is a vital monitoring capability. Metadata of packets (representative of data flow) is sent from the sender to a database for further processing and analysis, and the same operation is performed by the receiver.

The technique employs the database receiving information from a plurality of senders and receivers, with respective flows between respective senders and receivers sharing common UID and water markers to allow unique flow analyses. The database stores and arranges the information for further analysis by a processing block that evaluates common network impairments, packet loss detection, receiver jitter, delay variation between sender and receiver, packet reordering, TTL decrement, RTT and MTU. Existence of a detected artifact is immediately alerted to the end user/management. The processing unit processes the information against historical information to detect trends (for example but not limited to: burst loss pattern, increase of packet latency to highlight a congested network element, TTL changes to signal routing changes in the network, reordering window to signal a network reroute, and a burst of packets). Trends are presented to the user to take action.

Embodiments of the current invention include a system directed to detect a test stream sent from one sender over multiple paths and splitting an original stream into portions of streams of different sizes. Portions may be split with or without duplication (i.e., the same packets may be sent over multiple paths). Respective portions carry an original stream UID and watermarks to allow a receiver to re-aggregate the portions back to one continuous stream and to subsequently pass the information to the database for further analysis by a processing block.

Embodiments of the current invention include a system to detect the test stream sent from one sender over multiple paths and to duplicate the original/source stream so that a complete stream duplicate is sent over respective multiple paths. All stream duplicates carry an original stream UID and watermarks to allow a receiver to re-aggregate the stream duplicates to one continuous stream and to subsequently to pass the information to the database for further analysis by a processing block as one stream. The receiver is also capable of collecting the information of each path and of sending it to the database and the processing block for analysis to identify path specific network impairments.

Embodiments of the current invention include a system to detect additional network streams exiting/entering the sender/receiver and a plurality of network interfaces and to detect availability of respective traffic streams and respective bitrate and behavior to be correlates with artifacts by the processing block. For example, the sender may detect data traffic destined to a remote location that consumes 90% of available network bandwidth and which impacts the reference and packet streams between the sender and receiver. Such detection allows the user to divert or set QoS (quality of service setting) on the rouge network flow to avert such problems in the future.

Embodiments of the current invention include the processing unit configured to detect artifacts on a sender-generated packet stream injected into the network to reach a plurality of receivers including a collector/collector block, with both sender and receiver interacting with the database and the processing unit to detect network artifacts upon one or more reference network streams. The system comprises devices and non-transitory computer-readable storage media having executable computer modules, including:
a sender interacting with the network, the sender configured to:
   prepare a test packet stream; and,
   the packet streams including a timestamp for each packet, sequence number, UID, watermark and payload embedded information;
   detect reference streams on the network,
   encapsulate a packet stream session and transmit the stream through one or more broadcast networks,
   forward the test packet stream to a plurality of receivers connected over one or more network, IP service providers and paths,
   collect network statistics from any available network interface of any IP flow statistics; bitrate, packet rate, MTU and more; and forward the information to database,
   send metadata of every packet to a database with information about the UID, sequence number, timestamp, MTU size, TTL, water mark and payload information; and
a receiver interacting with the network, the receiver including a collector block configured to:
   receive the test packet stream from a sender via one or more networks (broadcast, broadband, mobile and any IP based network) and to extract the information within,
   detect the test packets, check for the watermark, UID, extract every packet sequence number, timestamp, TTL, MTU size and any additional information in the payload, and add a local arrival time for each test packet to create a metadata on each packet,
   forward the metadata to a database for further processing and analysis,
   collect network statistics from any available network interface of any IP flow statistics; bitrate, packet rate, MTU and more; and forward the information to database,
a database and processing block interacting with the network, database and processing block configured to:
   receive and collect metadata from plurality of senders and collectors;
   the processing block reading the metadata from senders and collectors to compare, and extract information on packet loss, latency variation between the sender and the collector, incoming network Jitter, reordering, TTL changes, MTU changes; and
   alert the user of any immediate problems; Packet loss high jitter, MTU changes, TTL changes and more, and
   predict trends of artifacts from the information gather overtime to alert the system user of such trends,
   process the statistics, and to transmit the processed statistics to the user management and orchestration center through the network; and
   receive commands from the management and orchestration center via the network and execute these commands,
a user management and orchestration center interacting with the network, the user management and orchestration center configured to:
   receive processed statistics from a recovery server via the network, and
   command and control a recovery server and a sender via the network.

It will be appreciated that the above descriptions are intended only to serve as examples, and that many other embodiments are possible within the scope of the present invention and as defined in the appended claims.

1. A system for actively monitoring and evaluating network artifacts on high throughput data over IP based networks, the high throughput data having packet streams with metadata, the streams delivered over a plurality of paths, the packet streams having packets, the system comprising:
at least one sender block having at least one sender network interface and an injector, the at least one sender block configured to send a plurality of sender packet streams into and out of the at least one sender network interface;
at least one receiver block having at least one receiver network interface and a collector, the at least one receiver block configured to receive a plurality of receiver packet streams into and out of the at least one receiver network interface;
a database configured to receive metadata from streams exiting the at least one sender block and metadata of streams entering the at least one receiver block;
the plurality of sender packet streams includes at least one source stream and at least one injected stream, the injected stream having packets with stamped metadata information, the injected stream additionally having metadata, and metadata of respective streams into and out of the at least one sender network interface being pushed to the database by the injector;
the plurality of receiver packet streams includes at least one test stream having packets with stamped metadata information, at least one reference stream, and a network stream, with metadata of respective streams into and out of the at least one receiver network interface, the metadata being pushed to the databases by the collector;
a processing block in communication with the database and with a user application; and
wherein the processing block is configured to process metadata and stamped metadata information of respective packet streams over the plurality of paths and to interact with the user application and management, the system further configured to measure, alert, and to predict an impact of probed and evaluated network artifacts on future packet streams based on metadata, stamped metadata information, and path analysis.

2. The system of claim 1, wherein the injector and the collector are in communication with a time source, the time source configured to provide timestamping for packets of the at least one injected stream and of at least one reference streams.

3. The system of claim 2, wherein the stamped metadata information includes at least: a creation timestamp; a time-to-live (TTL); a unique identifier (UID); a sequence number; a watermark; and axillary information.

4. The system of claim 3, wherein the at least one injected stream is an at least one test stream and stamped metadata information of packets of the at least test stream is compared with the stamped metadata information of packets of the at least one source stream by the processing block.

5. The system of claim 4, wherein the comparison of metadata by the processing unit includes a determination of: a presence of and an ordering of respective packets; and timing differences of respective packets over the plurality of paths to detect ad hoc network artifacts.

6. The system of claim 5, wherein the processing unit is further configured to examine metadata of packets over time to calculate trends.

7. The system of claim 6, wherein the processing unit is further configured to alert management of network artifacts and of trends.

8. A method for actively monitoring and evaluating network artifacts on high throughput data over IP based networks, the high throughput data having packet streams with metadata, the streams delivered over a plurality of paths, the packet streams having packets, the method comprising:
taking at least one sender block having at least one sender network interface and an injector, the at least one sender block sending a plurality of sender packet streams into and out of at least one sender network interface;
taking at least one receiver block having at least one receiver network interface and a collector, the at least one receiver block receiving a plurality of receiver packet streams into and out of the at least one receiver network interface;
configuring a database receiving metadata from packets of streams exiting the at least one sender block and metadata from packets of streams entering the at least one receiver block;
whereby the plurality of sender packet streams includes at least one source stream and at least one injected stream, the injected stream having packets with stamped metadata information, the injected stream additionally having metadata, and metadata of respective streams into and out of the at least one sender network interface is pushed to the database by the injector;
whereby the plurality of receiver packet streams includes at least one test stream having packets with stamped metadata information, at least one reference stream, and a network stream, with metadata of respective streams into and out of the at least one receiver network interface, the metadata is pushed to the databases by the collector;
having a processing block in communication with the database and with a user application; and
whereby the processing block processes metadata and stamped metadata information of respective packet streams over the plurality of paths and interacts with the user application and management, the system further configured to measure, alert, and predict an impact of probed and evaluated network artifacts on future packet streams based on metadata, stamped metadata information, and path analysis.

9. The method of claim 8, whereby the injector and the collector communicate with a time source, the time source providing timestamping for packets of the at least one injected stream and of at least one reference streams.

10. The method of claim 10, whereby the stamped metadata information includes at least: at least: a creation timestamp; a time-to-live (TTL); a unique identifier (UID); a sequence number; a watermark; and axillary information.

11. The method of claim 11, whereby the at least one injected stream is at least one test stream, and the processing block compares the stamped metadata information of packets of the at least test stream with stamped metadata information of packets of the at least one source stream.

12. The method of claim 12, whereby comparing metadata by the processing unit includes determining: a presence of and an ordering of respective packets; and timing differences of respective packets over the plurality of paths to detect ad hoc network artifacts.

13. The method of claim 13, whereby the processing unit further examines metadata of packets over time to calculate trends.

14. The method of claim 14, whereby the processing unit further alerts management of network artifacts and of trends.
